(19) United States
(12) Patent Application Publication
(10) Pub. No.: US 2007/0213103 A1
(43) Pub. Date: Sep. 13, 2007

(54) Mobile Terminal Device

(75) Inventor: Masayuki Zaitsu, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi (JP)

(21) Appl. No.: 11/467,483

(22) Filed: Aug. 25, 2006

(30) Foreign Application Priority Data
Aug. 30, 2005 (JP) 2005-250340

(51) Int. Cl. H04M 1/00

(52) U.S. Cl. 455/575.3

(57) ABSTRACT

A mobile terminal device provided with a camera device able to be made thinner without loss of aesthetic design, that is, a mobile terminal device including a first housing, a second housing, and a connection part connecting the first housing and second housing so that they can be opened and closed, wherein the first housing is formed, at an end part of a first surface facing the second housing in a closed state, with a step part expanded to hold a back surface of a camera module and a projecting part projecting from the step part, the second housing is formed, at its end part, with a cutaway part and is formed, at a second surface facing the first housing in the closed state, with a recessed part continuing from the cutaway part, and the connection part is configured to rotatably connect the projecting part and cutaway part, and when closed, connects the first housing and the second housing so that the step part fits into the recessed part.

### BACKGROUND OF THE INVENTION

1. Field of the Invention

The present invention relates to a mobile phone, laptop computer, or other mobile terminal device.

2. Description of the Related Art

Mobile phones mounting camera modules are known. In these kinds of mobile phones, the market is demanding increasingly sophisticated functions from the camera modules. For example, greater number of pixels, the provision of an auto-focus function, and the provision of an optical zoom function are being demanded. However, as these improved functions are provided, the camera modules become bigger in size. On the other hand, to secure good portability, thinner mobile phones are being demanded in the market. Therefore, the thicknesses of the camera modules have a large influence on the thickness of the housing.

Japanese Patent Publication No. 2002-171322 discloses in the section on prior art section a mobile phone in which a camera module is mounted on a circuit board in the housing in which the overall housing of the mobile phone is made thinner by using a housing sticking out at only the position where the camera is provided.

Also, Japanese Patent Publication No. 2002-171322 proposes to provide an opening in the circuit board in the housing and insert the camera module in the circuit board so as to enable the housing to be made as thin as the thickness of the camera module and not allow the module to stick out from the housing.

However, allowing the position where the camera module is provided to stick out sometimes detracts from the aesthetic design of the housing. Also, even if inserting the camera module into the circuit board to prevent the housing from sticking out, the housing can only be made as thin as the thickness of the camera module.

### SUMMARY OF THE INVENTION

An object of the present invention is to provide a mobile terminal device provided with a camera module which can be made thinner without detracting from the aesthetic design.

According to a first aspect of the present invention, there is provided a mobile terminal device including a first housing, a second housing, and a connection part connecting the first housing and the second housing so that they can be open-state and close-state, wherein the first housing houses a camera module, and has a first surface facing the second housing in the close-state, a step part formed at an connected end of the first surface and expanded to hold the camera module, and a projecting part projecting from the step part; the second housing has a second surface facing the first housing in the close-state, and is formed with a cutaway part at an connected end, and a recessed part continuing from the cutaway part on the second surface; the connection part is configured by fitting the projecting part into the cutaway part so as to rotate; and, in the close-state, the step part enters the recessed part, and the first surface and the second surface face each other with a distance which is less than a height of the step part from the first surface.

Preferably, an input or output user interface is arranged on the second surface, and the recessed part is formed in the region between the user interface and the cutaway part.

Preferably, a length of the step part in a direction of rotate axis of the connection part is shorter than a length of the cutaway part in the direction of rotate axis.

Preferably, each both ends of the cutaway part, the recessed part, and the user interface in parallel direction of the rotate axis, are arranged with continuous lines.

Preferably, the second housing houses an antenna for communication at a region where is not overlapping with the step part in the closed state.

Preferably, the recessed part is formed so that an amount of recess of the user interface side is smaller than an amount of recess of the cutaway side with respect to second surface.

Preferably, the user interface is a key control part provided with a plurality of keys arranged along the continuous lines.

Preferably, the projecting part and the cutaway part have holes communicating with each other when in a coupled state, and a signal line for transmitting a control signal to the camera module from the user interface along with input is inserted into the holes.

According to a second aspect of the present invention, there is provided a mobile terminal device including a first housing, a second housing, a connection part connecting the first housing and the second housing so that they can be open-state and close-state and a camera module built in the first housing, wherein the connection part is configured by a step part and cutaway part, the step part provided at the first housing, sticking out from a surface facing the second housing in the close-state and inserted in a cutaway part provided in the second housing so as to rotate, and the step part holds at least part of the camera module.

According to the mobile terminal device of the present invention, the housing having the camera module built in can be made thinner without causing any loss in aesthetic design.

### BRIEF DESCRIPTION OF THE DRAWINGS

These and other objects and features of the present invention will become clearer from the following description of the preferred embodiments given with reference to the accompanying drawings, in which:

FIG. 1 is an exterior perspective view showing a mobile phone of an embodiment of the present invention in an opened state;

FIGS. 2A and 2B are exterior perspective views showing the mobile phone of FIG. 1 in a closed state;

FIG. 3 is a perspective view seen from the front side showing the vicinity of the connection part of the mobile phone of FIG. 1 in an opened state;

FIG. 4 is a perspective view seen from the back side showing the vicinity of the connection part of the mobile phone of FIG. 1 in an opened state;

FIG. 5 is a view seen from the connection part side showing the vicinity of the connection part of the mobile phone of FIG. 1 in a closed state;

FIG. 6 is a sectional view in the direction of the VI-VI arrows in FIG. 2A; and

FIG. 7 is an exploded perspective view showing the detachment of the camera module.

### DESCRIPTION OF THE PREFERRED EMBODIMENTS

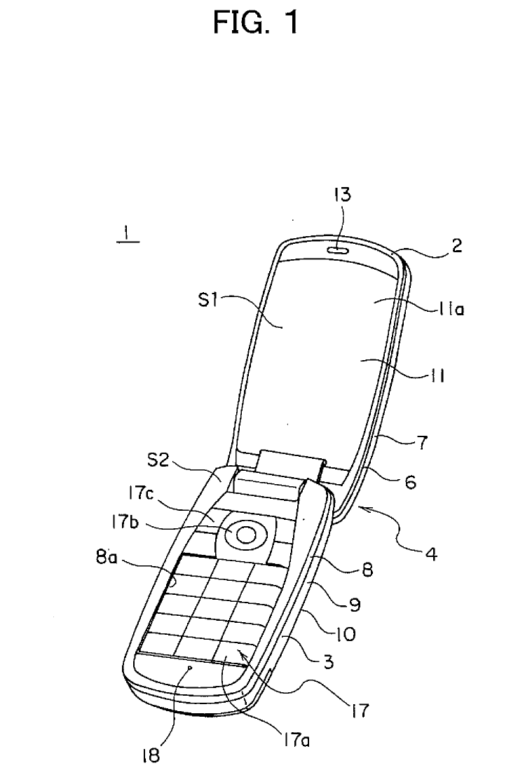

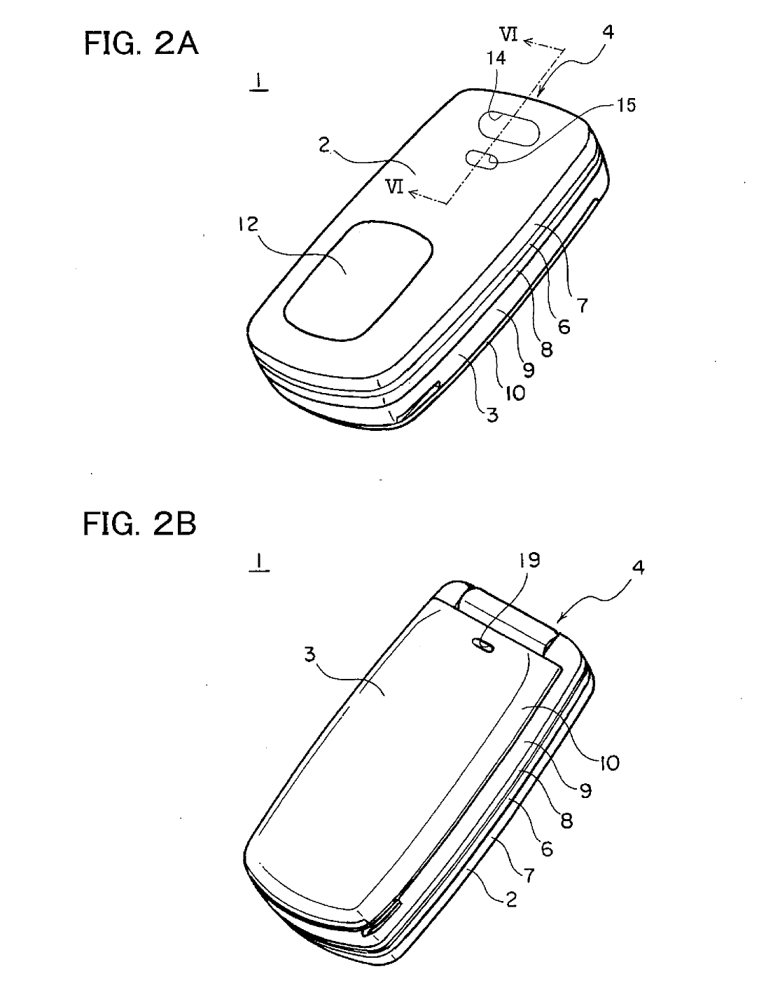

FIG. 1 and FIGS. 2A and 2B are exterior perspective views showing the mobile phone 1 according to an embodiment of the present invention. The mobile phone 1 is configured as a so-called clamshell type mobile phone. FIG. 1 shows the opened state, while FIG. 2A and FIG. 2B show the closed state.

The mobile phone 1 is provided with a first housing 2 and a second housing 3. The ends of the first housing 2 and the second housing 3 are each connected by a connection part 4. The mobile phone 1 can open and close centered about the connection part 4. The first housing 2 and the second housing 3 are formed as generally thin box shapes which are superposed over each other in a closed state. The contours substantially match each other when from one housing side the other housing side.

The first housing 2 is provided with a front case 6 in the front side that the surface (the front surface, the first surface S1) facing the second housing 3 in a closed state and a back case 7 in the back side. The front case 6 and the back case 7 are each formed, for example, by plastic. The front case 6 of the first housing 2 is formed with a sound emission port 13 for the communication speaker, while the back case 7 is formed with an camera module window 14 and a flash window 15.

The first housing 2 is provided with a main display part (display user interface) displaying an image on the front surface, a sub display part 12 displaying an image on the back surface, etc. The main display part 11 and the sub display part 12 are, for example, configured by liquid crystal displays. The main display part 11, for example, has at least half the area of the front surface of the first housing 2. The majority of the front surface of the first housing 2 is covered by a protective cover 11a of the main display part 11. The protective cover 11a is, for example, formed by an acrylic sheet.

The second housing 3 is provided with a front case 8 in the front side that the surface (front surface, the second surface S2) facing the first housing 2 in the closed state, a back case 9 in the back side, and a cover 10 covering the back side of the back case 9. The front case 8, the back case 9, and the cover 10 are formed, for example, from plastic. The front case B of the second housing 3 is formed with a sound collection port 18 for the speech-use microphone, while the cover 10 is formed with a sound emission port 19 for an alert speaker.

The second housing 3 is provided with a control part (operation user interface) 17 receiving user operations. The control part 17 is provided with for example dial keys 17a, cursor keys 17b, function keys 17c, and other various buttons which are exposed from the front case 8. Further, the buttons of the control part 17 are provided continuously (adjoining each other). Between the buttons, there are no partitions (frames) separating the buttons. That is, in the key area of the front case 8 is provided with a single opening 8a. The keys 17a to 17c are exposed from that opening 8.

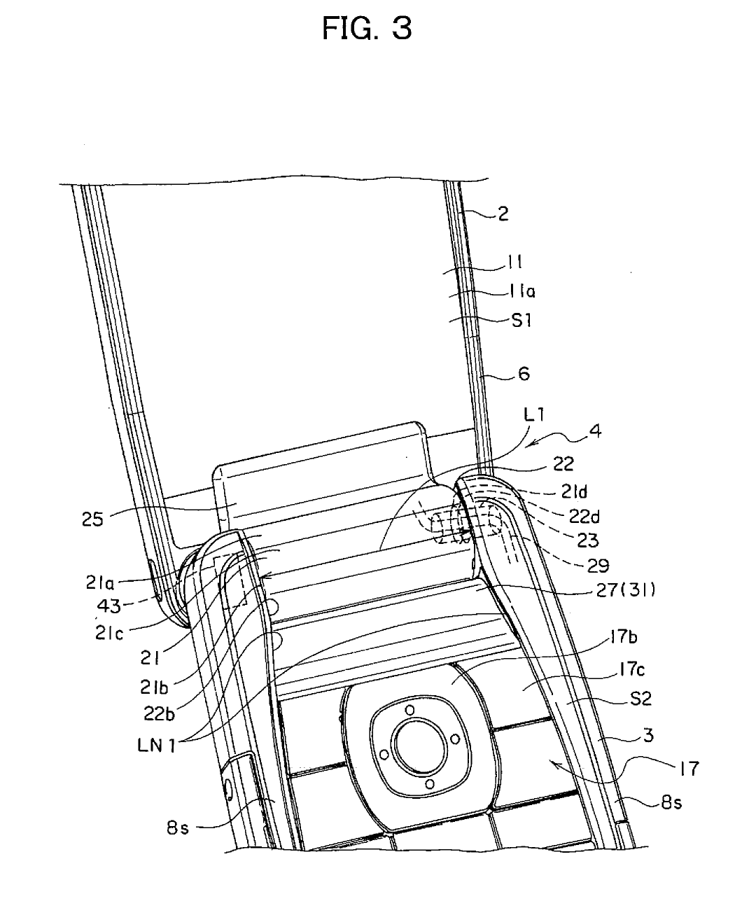

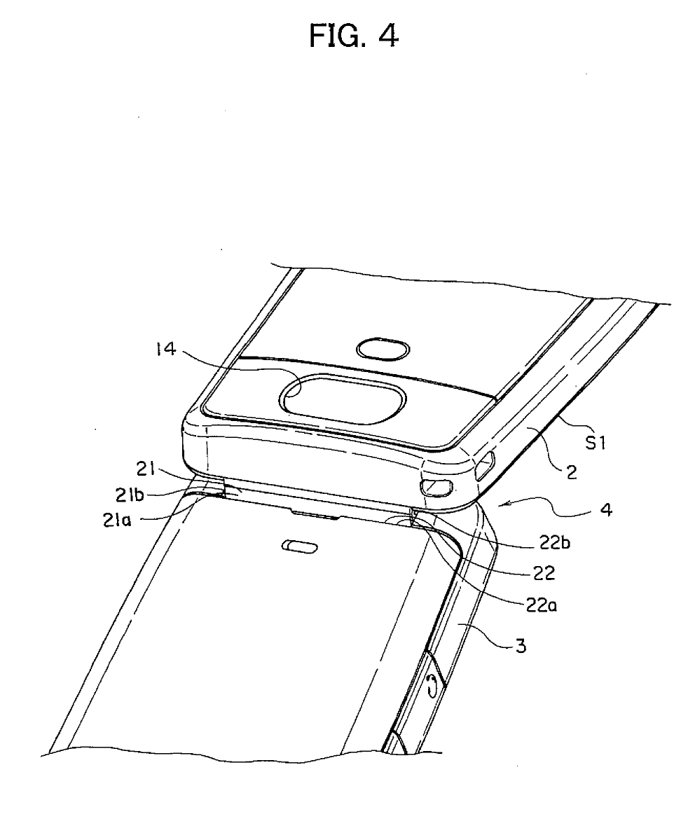

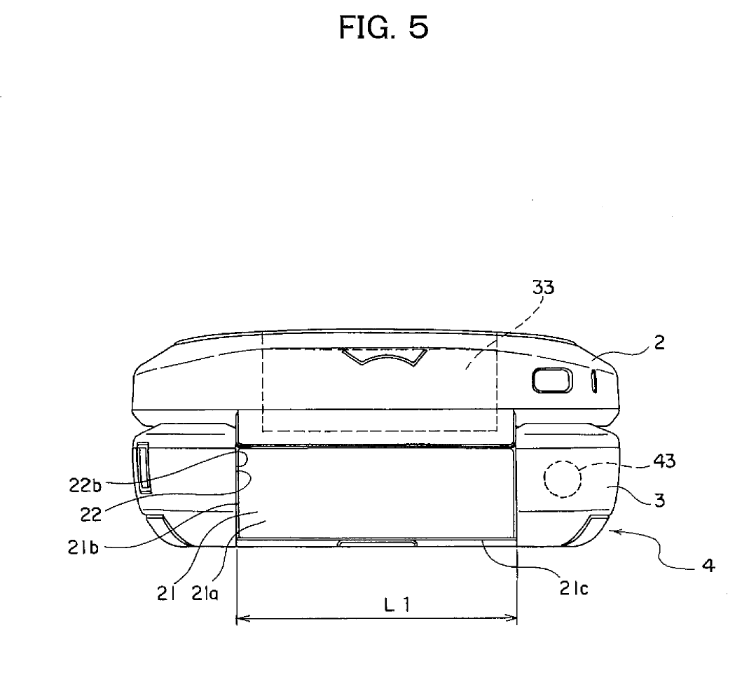

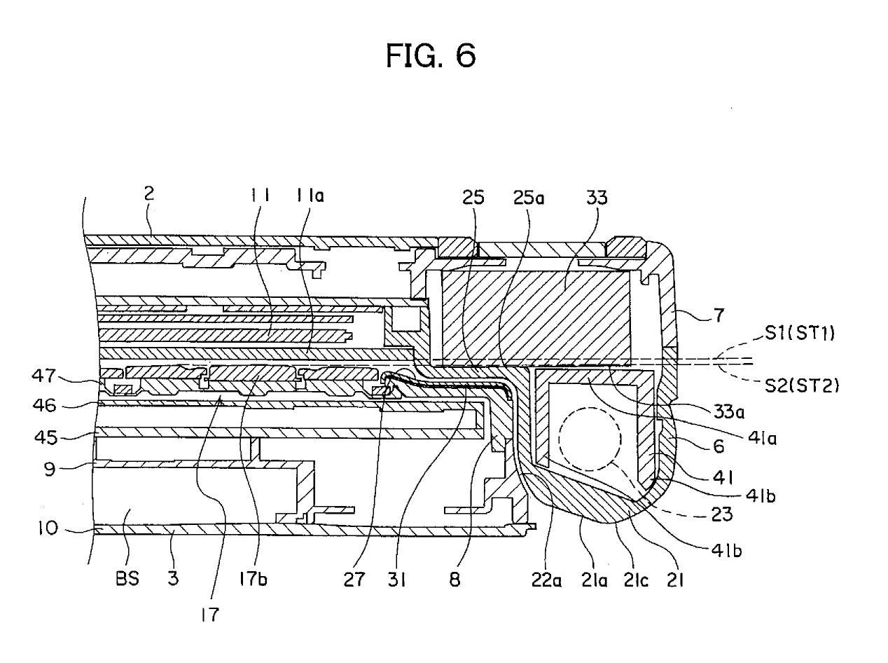

FIG. 3 is a diagram of the vicinity of the connection part 4 of the mobile phone 1 in the opened state as seen from the front side, FIG. 4 is a diagram of the vicinity of the connection part 4 of the mobile phone 1 in the opened state as seen from the back side, FIG. 5 is a diagram of the vicinity of the connection part 4 of the mobile phone 1 in the closed state as seen in parallel to the facing surfaces of the first housing 2 and the second housing 2, and FIG. 6 is a sectional view showing the vicinity of the connection part 4 of the mobile phone 1 in the closed state (a sectional view in the direction of the VI-VI arrows in FIG. 2A).

As shown in FIG. 3 to FIG. 5, the connection part 4 is configured so that a projecting part 21 projected from one end of the first housing 2 is fit into a cutaway part 22 provided at one end of the second housing 3 and so that shaft members 23 are passed through wall parts of the cutaway part 22 and the projecting part 21. The first housing 2 and the second housing 3 can rotate with respect to each other about the shaft members 23. The projecting part 21 projects from the step part 25 and forms a part of the step part 25. As shown in FIG. 6, in the closed state, the step part 25 is put in a recessed part 27 continuing from the cutaway part 22 and the first surface S1 and the second surface S2 face each other across a distance smaller than the height of the lower part of the step part 25 from the first surface S1. Further, the clearance between the first surface S1 and the second surface S2 is secured, for example, by having a projecting part provided at either of the first surface S1 or the second surface S2 contact the other. The projecting part is not shown in particular, however, it is configured by a rubber protruding member provided in the vicinity of the sound emission port 13 or the sound collection port 18.

As shown in FIG. 3 to FIG. 6, the projecting part 21 is provided at the first surface S1 side of the first housing 2. The projecting part 21 and the step part 25 are formed integrally with the front case 6 by a plastic for example. The projecting part 21 is provided at the center of the end of the first housing 2 in the direction of rotate axis and is formed in general into a half cylindrical shape about the rotational axis. The projecting amount of the projecting part 21 from the first surface S1 is formed to be equal to or slightly smaller than, for example, the thickness of the second housing 3. This is to prevent the projecting part 21 projecting from the front surface or back surface of the second housing 3 in a way which causes loss of aesthetic design in either the opened or closed state. The length L1 of the projecting part 21 in the direction of rotate axis is set to be comparatively long. For example, it is set to be 50 to 70% of the width of the first housing 2 and the second housing 3.

The lower part of the step part 25, for example, is formed in a box shape and is formed to be much higher than the first surface Si. The width of the lower part of the step part 25 in the direction of rotate axis is set to be the equivalent of the width of the projecting part 21. Note that as the projecting part 21 can be fitted into the cutaway part 22, so the width of the lower part of the step part 25 is smaller than the width of the cutaway part 22. In the direction perpendicular to the direction of rotate axis, the width of the lower part of the step part 25 is set to be larger than the width of the projecting part 21, and the projecting part 21 projects from the position near the housing end of the step part 25. Note that the step part 25 fits in the cutaway part provided in the connection part 4 side of the protective cover 11a. The height of the step part 25 from the first surface S1 is set to be larger than the distance between the first surface S1 and the second surface S2 in the closed state.

The cutaway part 22 is, when looking in the direction perpendicular to the second surface S2, formed in a substantially rectangular shape of substantially the same size as the projecting part 21 and is positioned in the center of the end of the second housing 3. As shown in FIG. 6, there is a slight gap between the outer circumference 21a of the projecting part 21 about the rotational axis and the wall surface 22a of the cutaway part 22 about the rotational axis, so rotation of the projecting part 21 with respect to the cutaway part 22 is allowed. On the other hand, as shown in FIG. 3 to FIG. 5, the end face 21b of the projecting part 21 perpendicular to the rotational axis and the wall surfaces 22b of the cutaway part 22 straddling the projecting part 21 abut against each other. These surfaces slide when the mobile phone 1 is opened or closed.

The recessed part 27 is formed in the region between the cutaway part 22 and the control part 17 so that it becomes concave with respect to the second surface S2. The recessed part 27, for example as shown in FIG. 6, is formed from a recess at the end of the front case 8 of the second housing 3 at the connection part 4 side and with that recess covering by an aluminum or other conductive sheet 31. The conductive sheet 31 blocks noise from the later mentioned camera module 33 and noise entering the camera module. However, the conductive sheet 31 may be replaced with conductive paint. By connecting these conductive parts to the reference potential line, it is also possible for static electricity to be grounded at the reference potential line even if the control part 17 is touched with a charged finger. Note that it is also possible to just form a recess in the front case 8 and not provide any conductive sheet etc. for shielding purposes.

As shown in FIG. 6, the recessed part 27 is formed so that the recess gradually becomes deeper from the control part 17 side to the cutaway part 22 side and forms a natural slope from the key surface of the cursor keys 17b and the function keys 17c adjacent to the recessed part 27. That is, the amount of recess of the second surface S2 of the control part 17 side is smaller than the amount of recess of the second surface S2 of the cutaway part 22 side.

As shown in FIG. 3, the recessed part 27, when seen from the direction perpendicular to the second surface S2, is formed in a substantially trapezoidal shape becoming wider from the cutaway part 22 side to the control part 17 side. The width of the recessed part 27 at the cutaway part 22 side is equivalent to the cutaway part 22, while the width of the recessed part 27 at the control part 17 side is equivalent to the width of the control part 17 at the recessed part 27 side. Therefore, the two ends of the cutaway part 22, the two ends of the recessed part 27, and the two ends of the control part 17 (the opening part of the second housing 3 exposing the dial keys 17a etc.) in the direction of rotate axis form continuous lines LN1. That is, there are no differences in level provided between these ends. For example, at the cutaway part 22, the lines extend in parallel. Starting from near the boundary between the cutaway part 22 and the recessed part 27 and to the control part 17, they curve smoothly outward gradually increasing in distance from each other.

Note that the projecting amount of the projecting part 21 and the step part 25 and the amount of recess of the recessed part 27 may be determined by using the mating surfaces as seen from the outside when closing the first housing 2 and the second housing 3 as datum levels. For example, the datum level ST1 of the projecting amount of the projecting part 21 and the step part 25, for example, can be defined by the protective cover 11a of the main display part 11. Further, the datum level ST2 of the amount of recess of the recessed part 27, for example, can be defined by the circumferential part 8s of the control part 17 (see FIG. 3).

The shaft members 23, as shown in FIG. 3 and FIG. 6, for example, are configured including a cylindrical portion and are passed through holes 21d formed in the end faces 21b of the projecting part 21 and holes 22d formed in the wall surfaces 22b of the cutaway part 22. The shaft members 23 are pivotally supported with respect to at least one of the cutaway part 22 and the projecting part 21. Note that two shaft members 23 are provided corresponding to the two end faces 21b of the projecting part 21, however, only one is shown in FIG. 3. In one of the two shaft members 23, a signal line 29 electrically connecting the first housing 2 and the second housing 3 is inserted. Note that the other of the two shaft members 23 is provided with a click mechanism generating a click feeling during opening and closing.

As shown in FIG. 6, the camera module 33 is provided at an end of the first housing 2 at the connection part 4 side. The camera module 33 captures an image by receiving light from an opening window 14 of the first housing 2. The camera module 33 is formed slightly smaller than the step part 25 as seen from the direction perpendicular to the first surface S1. The back 33a of the camera module 33 is arranged at a position projecting out to the second housing 3 side from the first surface S1 by being put in the step part 25 (see FIG. 5). Note that because the camera module 33 projects out to the second housing 3 side from the first surface S1 at the base side of the projecting part 21, part of the camera module 33 can be considered to be stored in the projecting part 21.

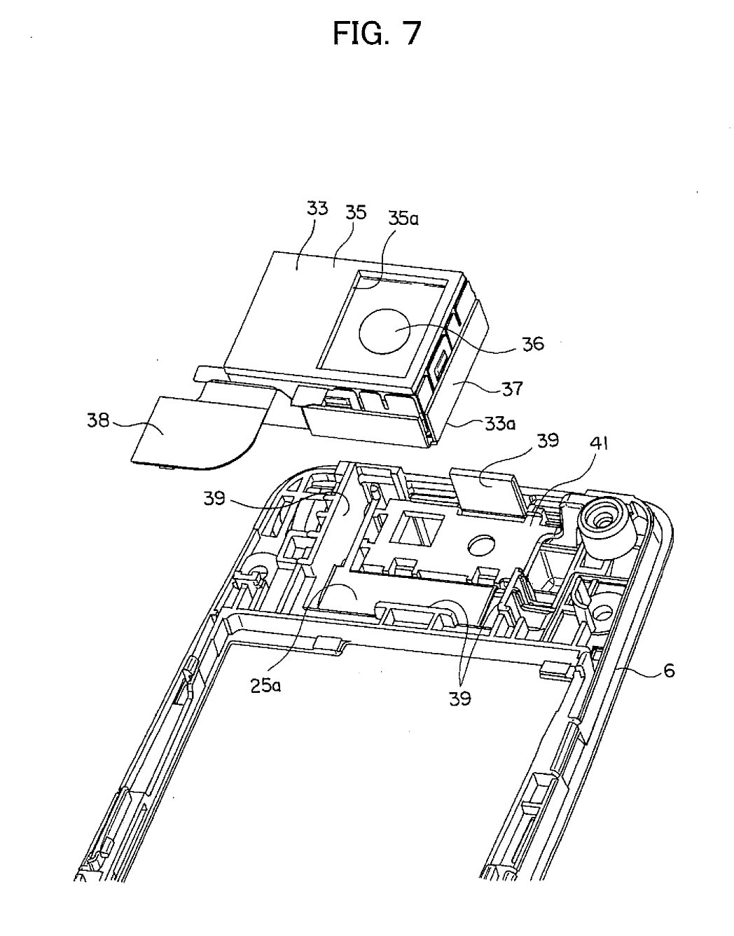

FIG. 7 is an exploded perspective view showing the state of the camera module 33 removed from the front case of the first housing 2. Further, the depth direction of the paper surface of FIG. 7 is the front direction of the paper surface FIG. 1.

The camera module 33 is provided with a substantially box shaped housing 35. The housing 35 is formed with an opening window 35a having a size of substantially half of the housing 35. The region of substantially half of the housing 35 at the opening window 35a side holds an optical module. The optical module is provided with optical lenses including a lens 36 exposed from the opening window 35a, a not shown mechanical shutter opening and closing the light path of the optical lenses, and a CCD, CMOS, or other not shown image capturing element which forms an image from the light of the optical lenses. The substantially half region of the housing 35 at the opposite side from the opening window 35a holds a not shown actuator driving the mechanical shutter of the optical module etc.

The camera module 33 is stored in a box-shaped shield case 37 and is connected to a flexible printed circuit (FPC) board 38 used for electrical connection to a not shown circuit board etc. inside the second housing 3. Note that the shield case 37 is attached to the camera module 33 to prevent noise from entering the image capturing element of the camera module 33, so may be considered a part of the camera module 33 as well.

The front case 6 is provided with a plurality of plate-shaped ribs 39 projecting out from the front side to the back side (housing inner side) for fixing in place the camera module 33. The camera module 33 is fit between the ribs 39 and thereby fixed in place with respect to the front case 6.

Further, the camera module 33 is arranged with its back facing the inner surface 25a of step part 25 and the camera holding member 41 provided in the projecting part 21 (see FIG. 6) and is covered by the back case 7 from the opening window 35a side, therefore it is fixed in place with respect to the front case 6 and the back case 7.

The camera holding member 41 is provided with an abutting part 41a against which the back of the camera module 33 abuts and support parts 41b supporting the abutting part 41a. The abutting part 41a is configured by, for example, a plate member substantially contiguous with the inner surface 25a of the step part 25. The support parts 41b are configured by, for example, two plate members perpendicular to the abutting part 41a and parallel to the rotational axis. The support parts 41b abut against the inner surface of the projecting part 21 and support the abutting part 41a. Note that the shaft member 23 is passed through the recess formed by the abutting part 41a and the two support parts 41b.

As shown in FIG. 6, the back case 9 of the second housing 3 is formed with a plurality of ribs at the inside and outside surfaces of the housing so as to form battery spaces BS and other spaces for holding electrical parts. The cover 10 is placed over the back case 9 so as to cover the storage spaces of the outside of the housing including the battery spaces.

The inside of the housing of the back case 9 holds a main circuit board 45 provided with not shown high-frequency circuits etc. The main circuit board 45 is covered by a shield case (not shown) shielding the high-frequency circuits etc. A key FPC 46 provided with a plurality of pressure switches (not shown) is provided on the shield case. A key sheet 47 for pressing the pressure switches is provided on the key FPC 46. The key sheet 47 is covered by the front case 8, so the key sheet 47 is fixed in place between the key FPC 46 and the front case 8. The key sheet 47 is formed, for example, by silicon.

Keys 17a to 17c are fixed in place to the key sheet 47 by an adhesive etc. A user can press the keys 17a to 17c to press the pressure switches of the key FPC 46 through the key sheet 47. Note that the control part 17 is configured by the keys 17a to 17c, key sheet 47, and key FPC 46.

The first housing 2 side of the signal line 29 shown in FIG. 3 is for example connected to the FPC 38 of the camera module 33 through the circuit board for controlling the main display part 11 etc. Also, the second housing 3 side of the signal line 29 is for example connected to the main circuit board 45 (see FIG. 6). The main circuit board 45 is provided with a not shown CPU outputting various types of control signals based on signals from the control part 17. Therefore, the signal line 29 transmits, for example, the signals from the control part 17 to the camera module 33 through the CPU of the main circuit board 45.

As shown in FIG. 3 and FIG. 5, the second housing 3 has an antenna 43 for transmitting and receiving radio waves built into it. The antenna 43 is arranged at the end of the second housing 3 at the connection part 4 side where the projecting part 21 is held. Therefore, in the closed state, the antenna 43 does not overlap the step part 25 at least in the direction of rotate axis of the connection part 4. Note that the antenna 43 may be arranged at any suitable position where it does not overlap the step part 25 as seen in the superposed direction of the first housing 2 and the second housing 3 when in the closed state. Also, the mobile phone 1 may have antennas other than antenna 43. When it has antennas other than the antenna 43, the antenna 43 may be used for sending and receiving phone calls, e-mail, etc. and used constantly as the main antenna or may be used when a particular application is started up and the amount of communication increase as a sub-antenna.

According to the above embodiment, the step part 25 secures the necessary thickness for storing the camera module 3 in the housing, so the camera module 33 can be held without increasing the thickness of the first housing 2 as a whole. Further, the step part 25 includes as one part the projecting part 21 forming the connection part 4, and the recessed part 27 in which the step part 25 is stored in the closed state is contiguous with the cutaway part 22 forming the connection part 4, so the step part 25 and the recessed part 27 do not stand out detracting from the appearance of the mobile phone 1.

The step part 25 has a length in the direction of rotate axis of the connection part 4 shorter than the length of the cutaway part 25 in the direction of rotate axis, so the step part 25 will not abut against the cutaway part 22 and hinder opening and closing when opening and closing the mobile phone 1.

The two ends of the cutaway part 22, the two ends of the recessed part 27, and the two ends of the control part 17 in the direction of rotate axis of the connection part 4 form continuous lines LN1, so the recessed part 27 stand outs even less. Also, the shape of the second housing 3 becomes simplified, so the die fabrication work for injection molding and other manufacturing work become easier.

The second housing 3 has a built-in antenna 43 for communication purposes at a position not overlapping the step part 25 in the direction of rotate axis of the connection part 4 when closed, so interference between the camera module 33 and the antenna 43 is reduced.

The recessed part 27 is formed so that the amount of recess of the control part 17 side with respect to the second surface S2 is smaller than the amount of recess of the cutaway part 22 side with respect to for the second surface S2, so a sufficient amount of recess for storing the step part 25 in the closed state can be secured while keeping the recessed part 27 from standing out. Further, the position of the recessed part 27 can be determined by the change in the amount of recess as felt by the fingertips, so touch-typing of the keys becomes easier.

The dial keys 17a and the function keys 17c are arranged along lines LN1, so the positions of the keys can be easily felt by the fingers and thus operation of the keys becomes easier. For example, a finger can be slid along a line LN1 and made to abut against the keys along the line LN1. Further, at this time, the recess of the recessed part 27 can be felt by the fingers and thereby the boundary line of the control part 17 at the connection part 4 side can be recognized. Due to this, touch-typing becomes easier.

The projecting part 21 and the cutaway part 22 have holes 21d, 22d connected to each other in a coupled state. The signal line 29 transmitting control signals between the camera module 22 and the control part 17 is inserted into the holes 21d, 22d. Therefore, the projecting part 21 houses not only the camera module 22, but also the signal line 29, so the space inside the projecting part 21 can be effectively used.

At least one of the camera module 33 is stored in the step part 25 containing in one part the projecting part 21 to be fit in the cutaway part 22, so the thickness for storing the camera module 33 can be secured without detracting from the appearance of the mobile phone 1.

The present invention is not limited to the above embodiment and can be worked in various ways.

The mobile terminal device of the present invention may be any one where a projecting part of a first housing and a cutaway part of a second housing are connected to be openable and closable and a camera module is provided in the first housing. Therefore, the invention is not limited to a mobile phone and may be also be used for example for a laptop computer or PDA.

The step part may be any one provided at a first housing, projecting from a first surface facing a second housing in a closed state, having at least part rotatably connected to a cutaway part of the second housing, and holding at least part of the back of a camera module. Its size and shape are not critical. For example, the end of the first housing may also be provided with two step parts in the direction of rotate axis and one step part may hold the camera module. The length of the step part in the direction of rotate axis may be shorter than a half of the length of end of the first housing in the direction of rotate axis. However, if, as in the above embodiment, providing only one step part at the end of the first housing and making the length in the direction of rotate axis at least half the width of the first housing, a comparatively large space can be secured inside the step part and therefore storage of the camera module becomes easier. Also, the step part may be provided with keys etc.

The projecting part and the recessed part are not absolutely necessary. For example, when the camera module is smaller than the cutaway part configuring the connection part, the step part can be used to store the entire camera module and the entire step part can be inserted into the cutaway part to form the connection part thereby enabling the recessed part to be eliminated.

The recessed part may be any one provided contiguous with the cutaway part and able to hold the step part in the closed state. Therefore, the recessed part may be suitably set in shape and size. The recessed part may also be provided with relatively small keys and other provided with a user interface.

The user interface provided at the second housing at the opposite side of the cutaway part from the recessed part is not limited to a key control part. For example, it may also be a display part. Note that in this case, the two ends of the cutaway part, the two ends of the recessed part, and the two ends of the display part may also form continuous lines.

The key control part is not limited to a plurality of keys arranged continuously (without partitions between keys). Therefore, each key may be individually partitioned off or the keys may be partitioned into predetermined groups. However, when removing the partitions between the keys, the key control part is reduced in size by the amount of the removed partitions, and the keys may be made bigger.

Note that, when removing the partitions between the keys, detecting the positions of the keys by the fingertips may become difficult. However, this problem can be solved by providing the recessed part or the continuous lines (LN1) and making it possible to feel the boundary of the region of the keys. For example, when at least two keys are arranged consecutively in a direction away from the recessed part, by detecting the recessed part by the fingertips, it is possible to recognize the boundary of the recessed part side of the key and in turn determine the position of the key continuing after the first key near the boundary.

In the mobile phone 1 of the above embodiment, it is clear that the two ends of the cutaway part 22, the recessed part 27, and the control part 17 form continuous ridges and therefore form continuous lines. However, so long as the two ends of the cutaway part, two ends of the recessed part, and two ends of the user interface (the opening window of the housing where the user interface is exposed) continue without level differences, these two ends will form continuous lines when seen from a predetermined direction (for example, the direction perpendicular with the second surface of the second housing), so the continuous lines are not limited to ridges. Therefore, for example, the two ends of the cutaway part etc. may be chamfered to form curved surfaces and the curved surfaces may form the continuous lines. However, if ridges are formed, the ridges can be detected by the fingertips, so touch-typing of the keys becomes easier.

While the invention has been described with reference to specific embodiments chosen for purpose of illustration, it should be apparent that numerous modifications could be made thereto by those skilled in the art without departing from the basic concept and scope of the invention.

1. A mobile terminal device comprising:
a first housing;
a second housing; and
a connection part connecting said first housing and said second housing so that they can be open-state and close-state; wherein
said first housing houses a camera module, and has a first surface facing said second housing in the close-state, a step part formed at an connected end of said first surface and expanded to hold said camera module, and a projecting part projecting from said step part;
said second housing has a second surface facing said first housing in the close-state, and is formed with a cutaway part at an connected end, and a recessed part continuing from said cutaway part on said second surface;
said connection part is configured by fitting said projecting part into said cutaway part so as to rotate; and,
in the close-state, said step part enters said recessed part, and said first surface and said second surface face each other with a distance which is less than a height of said step part from said first surface.

2. A mobile terminal device as set forth in claim 1, wherein
an input or output user interface is arranged on said second surface, and
said recessed part is formed in the region between said user interface and said cutaway part.

3. A mobile terminal device as set forth in claim 2, wherein a length of said step part in a direction of rotate axis of said connection part is shorter than a length of the cutaway part in the direction of rotate axis.

4. A mobile terminal device as set forth in claim 3, wherein each both ends of said cutaway part, said recessed part, and said user interface in parallel direction of said rotate axis, are arranged with continuous lines.

5. A mobile terminal device as set forth in claim 1, wherein said second housing houses an antenna for communication at a region where is not overlapping with said step part in the closed state.

6. A mobile terminal device as set forth in claim 2, wherein said recessed part is formed so that an amount of recess of said user interface side is smaller than an amount of recess of said cutaway side with respect to second surface.

7. A mobile terminal device as set forth in claim 4, wherein said user interface is a key control part provided with a plurality of keys arranged along said continuous lines.

8. A mobile terminal device as set forth in claim 2, wherein
said projecting part and said cutaway part have holes communicating with each other when in a coupled state, and
a signal line for transmitting a control signal to said camera module from said user interface along with input is inserted into said holes.

9. A mobile terminal device comprising:
a first housing;
a second housing;
a connection part connecting said first housing and said second housing so that they can be open-state and close-state; and
a camera module built in the first housing; wherein
said connection part is configured by a step part and cutaway part, said step part provided at said first housing, sticking out from a surface facing the second housing in the close-state and inserted in a cutaway part provided in the second housing so as to rotate, and
said step part holds at least part of said camera module.
